(19) United States
(12) Patent Application Publication
(10) Pub. No.: US 2005/0094273 A1
(43) Pub. Date: May 5, 2005

(54) Optical film and optical display device having the same

(76) Inventors: Tomohiro Takao, Tokyo-To (JP); Takahiro Niimi, Tokyo-To (JP); Shoichi Komatsu, Yokohama-Shi (JP); Takanobu Tadaki, Yokohama-Shi (JP)

Correspondence Address: HARNESS, DICKEY & PIERCE, P.L.C., P.O. BOX 828, BLOOMFIELD HILLS, MI, 48303, US

(21) Appl. No.: 10/946,568

(22) Filed: Sep. 21, 2004

(30) Foreign Application Priority Data
Sep. 29, 2003 (JP) 2003-338128

(51) Int. Cl. G02B 1/10

(52) U.S. Cl. 359/586

(57) ABSTRACT

The present invention provides an optical film and an optical display device which can suppress the occurrence of interference fringes. The optical film comprises a plurality of transparent layers. A first transparent layer and a second transparent layer, provided in contact with the first transparent layer, constituting the optical film are different from each other in refractive index of material constituting the layer. The contact interface between the first transparent layer and the second transparent layer is a light scattering interface, whereby the occurrence of interference fringes is suppressed. The optical display device comprises this optical film.

### BACKGROUND OF THE INVENTION

The present invention relates to an optical film and an optical display device comprising the optical film.

Plate-like transparent materials such as glass and plastics have hitherto been used, for example, in displays for electronic equipment such as word processors, computers, and televisions, and other various display devices. These transparent materials, however, suffer from such a problem that transparency is likely to be deteriorated by, for example, adherence of dust by static electricity, adherence of contaminants, or abrasion or scratch.

Accordingly, it is common practice to form a hard coat on a transparent material or, if necessary, to provide other layer for imparting contemplated functions, for example, antistatic properties, antifouling properties, and antireflection properties, on the hard coat.

When the hard coat and the like are formed on the transparent substrate, however, light reflected from the surface of the transparent substrate interferes with light reflected from the surface of the hard coat and, consequently, disadvantageously, an uneven pattern called interference fringes or interference pattern caused by uneven layer thickness is visually perceived and appearance is deteriorated.

An example of a method for optically solving this problem is to bring the thickness of the hard coat layer or the like to an extremely large thickness of several μm or more or to a small thickness of about 100 nm. The former method is unrealistic, for example, due to the occurrence of cracking or high cost. On the other hand, the latter method suffers from a problem that satisfactory hard coat properties cannot be provided and cannot be said to be practical.

When the hard coat layer can be formed in a fully even layer thickness, interference fringes should not occur. However, it can be said that, in producing various commercial goods on a commercial scale, the formation of the hard coat layer in an even thickness which does not cause interference fringes is substantially impossible.

### DISCLOSURE OF THE INVENTION

An object of the present invention is to suppress the occurrence of interference fringes by providing an interface having specific properties between two transparent layers (that is, a transparent substrate layer and a hard coat layer).

Thus, according to the present invention, there is provided an optical film comprising a plurality of transparent layers, wherein a first transparent layer and a second transparent layer, provided in contact with said first transparent layer, constituting said optical film are different from each other in refractive index of material constituting the layer, and the contact interface between said first transparent layer and the second transparent layer is a light scattering interface, whereby the occurrence of interference fringes is suppressed.

In the optical film according to the present invention, preferably, the contact interface between said first transparent layer and the second transparent layer is a light scattering interface having a ten-point mean roughness Rz=not less than 0.4 μm as measured according to JIS B 0601-1994.

In the optical film according to the present invention, preferably, said first transparent layer comprises a substrate layer and an interference fringe preventive layer and the surface of the interference fringe preventive layer constitutes said light scattering interface.

Further, in the optical film according to the present invention, preferably, the material constituting said interference fringe preventive layer has a refractive index which is substantially equal to that of the material constituting said substrate layer.

In the optical film according to the present invention, preferably, said interference fringe preventive layer has been formed by a Benard cell method.

The optical film according to the present invention preferably comprises at least one of an antireflection layer, an antistatic layer, and an antifouling layer.

Further, the optical film according to the present invention is preferably an antireflection film comprising a transparent substrate layer and, provided on said transparent substrate layer in the following order, said first transparent layer comprising an antistatic layer and said second transparent layer comprising a hard coat layer.

In the present invention, there is provided an optical display device comprising any of the above optical films.

The optical film according to the present invention comprises a plurality of transparent layers, wherein a first transparent layer and a second transparent layer, provided in contact with said first transparent layer, constituting said optical film are different from each other in refractive index of material constituting the layer, and the contact interface between said first transparent layer and the second transparent layer is a light scattering interface. By virtue of this construction, the occurrence of interference fringes can be suppressed.

### BRIEF DESCRIPTION OF THE DRAWINGS

FIG. 1 is a typical cross-sectional view of a specific preferred embodiment of the optical film according to the present invention;

FIG. 2 is a typical cross-sectional view of a specific preferred embodiment of the optical film according to the present invention;

FIG. 3 is a typical cross-sectional view of a specific preferred embodiment of the optical film according to the present invention;

FIG. 4 is a typical cross-sectional view of a specific preferred embodiment of the optical film according to the present invention; and

FIG. 5 is a typical cross-sectional view of a conventional optical film.

### BEST MODE FOR CARRYING OUT THE INVENTION

The present invention will be described, if necessary, with reference to the accompanying drawings.

Optical Film

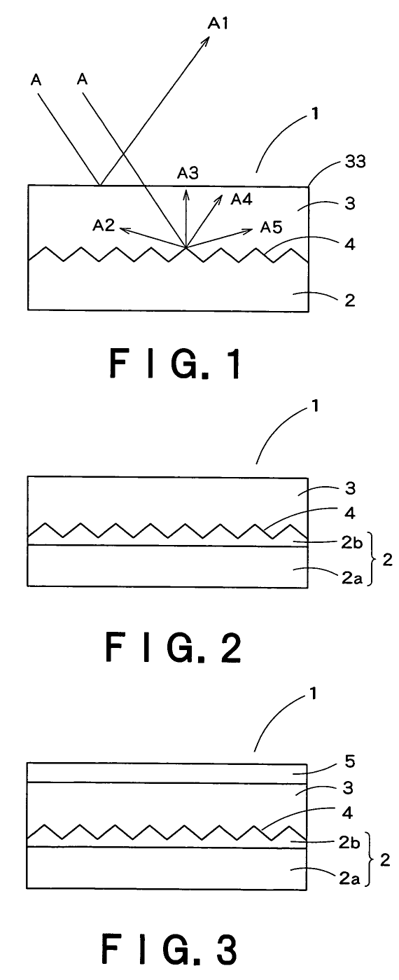

FIGS. 1 to 4 are typical cross-sectional views of specific preferred embodiments of the optical film according to the present invention.

In an optical film (1) according to the present invention shown in FIG. 1, a first transparent layer (2) and a second transparent layer (3) provided in contact with the first transparent layer are different from each other in refractive index of material constituting the layer, and the contact interface (4) between the first transparent layer (2) and the second transparent layer (3) is a light scattering interface, whereby the occurrence of interference fringes is suppressed.

In FIG. 1, the optical film (1) comprises two transparent layers of the first transparent layer (2) and the second transparent layer (3). Alternatively, the optical film according to the present invention may have a structure of three or more transparent layers.

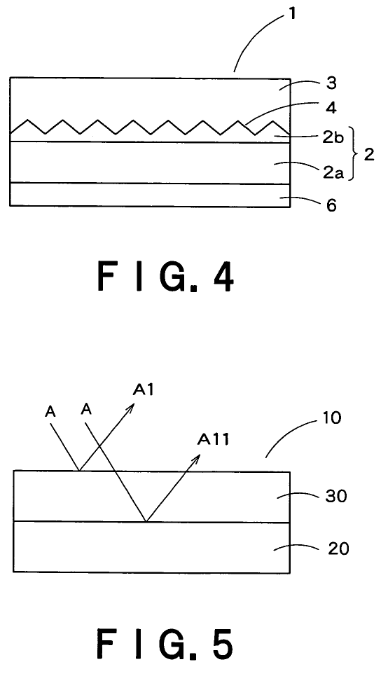

Specific examples of preferred optical films according to the present invention comprising three or more transparent layers include
an optical film shown in FIG. 2 in which the first transparent layer (2) comprises a substrate layer (2a) and an interference fringe preventive layer (2b), wherein the first transparent layer (2) and the second transparent layer (3) provided in contact with the first transparent layer are different from each other in refractive index of material constituting the layer, and the contact interface (4) between the first transparent layer (2) and the second transparent layer (3) is a light scattering interface, whereby the occurrence of interference fringes is suppressed,
an optical film shown in FIG. 3 in which other transparent layer (5) is provided on the surface of the second transparent layer (3), and
an optical film shown in FIG. 4 in which other transparent layer (6) is provided on the surface of the first transparent layer (2).

In the optical film (1) according to the present invention shown in FIGS. 1 to 4, a contact interface (4) of the first transparent layer (2) and the second transparent layer (3) is a light scattering interface. According to this construction, the occurrence of interference fringes of the optical film (1) is mainly suppressed. Specifically, a part of light (A) arrived at the optical film (1) according to the present invention from a viewer side is reflected from the surface of the optical film (in FIG. 1, a surface (33) of the second transparent layer (3)) (this reflected light being indicated by (A1) in the drawing). At the same time, a part of light transmitted through the second transparent layer (3) is reflected from the surface of the first transparent layer (2) (that is, from the contact interface (4)). Since this contact interface (4) is a light scattering interface, the light is reflected in various different directions from the contact interface (4) and is scattered (this reflected light being indicated by (A2) to (A5) in the drawing). As a result, the intensity of the light (A4) reflected in a direction parallel to the reflected light (A1) from the contact interface (4) is much lower than the intensity of the reflected light (A1). Thus, since the intensity of the reflected light (A4) is low, the interference between the reflected light (A1) and the reflected light (A4) is reduced and, consequently, the occurrence of interference fringes is suppressed.

In the case of the conventional optical film (10) as shown in FIG. 5, the intensity of reflected light (A11) is high, and interference of the reflected light (A11) with the reflected light (A1) is strong. Therefore, in this case, observed interference fringes are also strong.

In the optical films (1) according to the present invention shown in FIGS. 1 to 4, the contact interface (4) of the first transparent layer (2) and the second transparent layer (3) preferably has a ten-point mean roughness (Rz) of 0.4 to 3.5 μm, particularly preferably 0.7 to 2.0 μm, as measured according to JIS (Japanese Industrial Standards) B 0601-1994. When Rz is in the above-defined range, light scattering is satisfactory and the occurrence of interference fringes can be effectively suppressed. When Rz=less than 0.4 μm, the effect of preventing interference fringes is not satisfactory. On the other hand, when Rz=more than 2.0 μm, for some material for the second transparent layer (3), there is a possibility that the surface smoothness of the optical film is lowered, leading to limitation of applications. In the case of Rz=3.5 μm, even when the material for the second transparent layer (3) is selected, the formation of an optical film having a smooth surface in a coating thickness range suitable as an optical film is difficult.

In the optical film (1) according to the present invention shown in FIGS. 2 to 4, the substrate layer (2a) may be any appropriate one so far as it is transparent. For example, a transparent resin film which has hitherto been used in the optical film may be used. In the present invention, the particularly preferred substrate layer (2) may be formed of, for example, a polyester resin (preferably, “A-4100” and “A-4300” manufactured by Toyobo Co., Ltd.) or a cellulose triacetate resin (preferably, “TF 80 UL” and “FT TDY 80 UL” manufactured by Fuji Photo Film Co., Ltd.) or the like. The thickness of the first transparent layer is preferably 0.4 to 10.0 μm, particularly preferably 1.0 to 5.0 μm. This first transparent layer (2) is preferably formed of a material having antistatic properties from the viewpoint of preventing adherence of refuse caused by static electricity and adherence of soil.

In the optical film (1) according to the present invention shown in FIGS. 2 to 4, the interference fringe preventive layer (2b) is formed of a material which can form, as a predetermined light scattering interface, the contact interface (4) between this interference fringe preventive layer (2b) and the second transparent layer (3). Any method may be used for the formation of the interference fringe preventive layer (2b) having a predetermined light scattering interface. Examples of methods for interference fringe preventive layer (2b) include a method in which a material for interference fringe preventive layer (2b) formation is provided on the substrate layer (2a) by coating, lamination or the like and processing is then carried out so that an interference fringe preventive layer (2b) having a predetermined light scattering interface is formed, or a method in which an interference fringe preventive layer (2b) is formed on the substrate layer (2a) so that a predetermined light scattering interface is provided on the substrate layer (2a).

The refractive index of the material for interference fringe preventive layer (2b) formation may be substantially the same as or different from that of the material for substrate layer (2a) formation. The refractive index of the interference fringe preventive layer (2b) is preferably 1.50 to 1.70, particularly preferably 1.50 to 1.60.

In the present invention, the interference fringe preventive layer (2b) is particularly preferably formed by a Benard cell method. The term “Benard cell” as used herein refers to a form which has been caused by cell-like convection (the so-called Benard cell convection) which is created in the case where a horizontal fluid layer is heated from below to render the bottom temperature higher than the temperature of the upper surface resulting in a reduction in density toward the downward direction. This Benard cell per se is known as described, for example, in “Kotingu-Hado Gijutsu No Kako Genzai Kara Mirai Wo Manabu (Coating-Learning of future of hard technology from past and present -)” edited by Converting Technical Institute and “Kotingu Gijutus-Tofu Houshiki No Sentei, Souchi No Shiyoutekisei, Toraburu Taisaku, Kakushu Youto Ni Okeru Purosesu No Saitekika (Coating technology—Selection of coating method, suitability for use of apparatus, measures of troubles, and optimization of process in various applications)” edited by TECHNICAL INFORMATION INSTITUTE CO., LTD.

According to this Benard cell method, an interference fringe preventive layer (2b) having a predetermined light scattering interface can be formed easily and very efficiently on the substrate layer (2a). Regarding the formation of the interference fringe preventive layer (2b) by the Benard cell method, any method and conditions may be adopted so far as an interference fringe preventive layer (2b) having a predetermined light scattering interface can be formed.

Preferred method and conditions for the formation of the interference fringe preventive layer (2b) by the Benard cell method are as follows.

[Method for Interference Fringe Preventive Layer Formation]

Regarding the Benard cell method, i.e., one of method used in the present invention for providing satisfactory surface roughness on the surface of the interference fringe preventive layer, methods and conditions will be described.

In the coating liquid layer immediately after coating, the solvent is evaporated from the surface, and a difference in density or surface tension occurs between the surface and the inside of the coating, whereby drying proceeds while causing convection. The shape of convection fixed by drying is the so-called Benard cell. The cell shape is sometimes rounded under some conditions. The shape, however, is formed of a polygonal pattern of approximately triangle to heptangle and can easily be confirmed by observation under an optical microscope at a magnification of about 100 times.

Mere coating of a coating liquid prepared by diluting a resin with a solvent, however, cannot provide concaves and convexes having a satisfactory difference in level without difficulties when the coating thickness is in a range suitable as an optical film. This is attributable to the fact that, since the resin liquid is fluid until the end of drying, the cell shape cannot be efficiently fixed.

Accordingly, in the present invention, this problem was solved by dispersing a suitable amount of fine powder having a particle diameter of not more than 1 μm in a coating liquid. Since a suitable amount of fine powder is dispersed, the coating liquid rapidly lost fluidity at the end of drying and, consequently, the shape of the Benard cell could be efficiently fixed. Further, an interference fringe preventive layer having satisfactory surface roughness as an interference fringe preventive layer could be formed by properly regulating processing conditions such as the solvent, the resin component, the amount of the dispersant and the coating thickness, and drying temperature to efficiently produce convection in the drying process.

“Electrically conductive fine powder T-1” manufactured by Mitsubishi Materials Corporation and “IPA-ST-UP” manufactured by Nissan Chemical Industries Ltd. were used as fine particles, “M-215” manufactured by Toa Gosei Chemical Industry Co., Ltd. and “DPHA” manufactured by Dainichiseika Color & Chemicals Manufacturing Co., Ltd. were used as resin component, “Irgacure 184” manufactured by Ciba Specialty Chemicals, K.K. was used as a photopolymerization initiator, and isopropanol and isobutanol were used as solvents. In order to provide dispersion stability of “electrically conductive fine powder T-1,” a suitable amount of “SOLSPERSE 2000” manufactured by Avecia was incorporated as a dispersant.

Regarding mixing, a coating liquid was prepared by regulating the amount of a solvent so that, in terms of weight ratio after drying, when the resin content is presumed to be 100, the composition ratio is 10 for the photopolymerization initiator, 300 for the fine powder, and 17.5 to 33.3 for the dispersant, and regulating the solid content to 5 to 20%.

The larger the mixing ratio of the fine powder, the larger the surface roughness of Benard cell. In this case, however, the dispersion stability of the coating liquid is disadvantageously deteriorated. On the other hand, however, when the mixing amount of the dispersant is increased for improving the dispersion stability of the coating liquid, the dispersant functions as a surfactant to prevent convection of the coating liquid in the drying process. For this reason, the surface roughness of Benard cell cannot be increased. Therefore, the mixing ratio in the above range was adopted as a mixing ratio which can realize both the dispersion stability sufficient for practical use and satisfactory surface roughness.

In the mixing, when the solid content is lower than 5%, no satisfactory surface roughness could be realized although a triangular to heptangular pattern characteristic of the Benard cell is formed. On the other hand, in the mixing, when the solid content is higher than 20%, the Benard cell per se was not formed. For this reason, studies were made in a mixing ratio of 5 to 20%.

The larger the thickness of the layer before drying and the higher the drying temperature, the larger the surface roughness of the Benard cell. In this case, however, in the drying process, uneven drying is likely to occur. When uneven drying occurs in the drying process, in some cases, the uneven drying results in increased density of interference fringes even in the case where a hard coat is coated as a post-process. Since unevenness caused by drying can be visually judged, studies should be made on processing conditions which do not cause unevenness. Therefore, care should be taken to drying temperature depending upon suitability of the coating liquid.

A contemplated interference fringe preventive layer could be formed by coating the coating liquid prepared in the above mixing on a 188 μm-thick polyester resin film “A-4300” manufactured by Toyobo Co., Ltd. to a coating thickness of not less than 20 μm before drying, and rapidly drying the coating at a drying temperature of 40 to 100° C.

Actual ink formulations, drying conditions and shape of interference fringe preventive layer, and effect of preventing interference fringes will be described later in working examples.

In the optical films (1) according to the present invention shown in FIGS. 2 to 4, the second transparent layer (3) may be formed of, for example, a polyester resin (preferably, “A-4300” manufactured by Toyobo Co., Ltd.) or a cellulose triacetate resin (preferably, “TF 80 UL” and “FT TDY 80 UL” manufactured by Fuji Photo Film Co., Ltd.) or the like. The second transparent layer (3) preferably has a refractive index of 1.5 to 2.0, particularly preferably 1.5 to 1.7. Further, the interference fringe preventive layer (2b) and the second transparent layer (3) in the first transparent layer (2) should be different from each other in refractive index. When the difference in refractive index between the interference fringe preventive layer (2b) and the second transparent layer (3) is not less than zero (0), the effect of preventing interference fringes occurs. The difference in refractive index is particularly preferably 0.01 to 0.2. The refractive index of the interference fringe preventive layer (2b) may be higher than that of the second transparent layer (3), or vice versa.

This second transparent layer (3) is preferably formed of a hard material from the viewpoints of preventing scratching of the optical film according to the present invention and improving durability. Regarding such suitable hard materials, those which have hitherto been commonly used as the so-called material for hard coat layer formation in optical films can also be used in the present invention.

The optical film (1) according to the present invention preferably has at least one layer of an antireflection layer, an antistatic layer, and an antifouling layer. FIG. 3 shows an optical film (1) in which at least one of the antireflection layer, the antistatic layer, and the antifouling layer is provided as other transparent layer (5) on the surface (that is, surface on viewer side) of the second transparent layer (3). FIG. 4 shows an optical film (1) in which at least one of the antireflection layer, the antistatic layer, and the antifouling layer is provided as other transparent layer (6) on the surface (that is, surface remote from the viewer) of the first transparent layer (2).

Optical Display Device

The optical display device according to the present invention is characterized by comprising the above optical film.

### EXAMPLES

Various optical films shown in Table 1 were produced according to the following materials and methods.

Each of the optical films was measured for the following items. As a result, results shown in Table 1 were obtained.

[Preparation of Samples]

Samples of the present invention were prepared by coating an interference fringe preventive layer on a transparent substrate and coating a hard coat on the interference fringe preventive layer. The procedure for preparing the interference fringe preventive layer and the hard coat layer used in examples of the present invention will be described.

Substrate Layer

A 188 μm-thick polyethylene resin film (tradename: “A-4300,” manufactured by Toyobo Co., Ltd.)

Interference Fringe Preventive Layer A

30% by weight of “electrically conductive fine powder T-1” manufactured by Mitsubishi Materials Corporation, 10% by weight of “M-215” manufactured by To a Gosei Chemical Industry Co., Ltd., 1.75% by weight of “SOLSPERSE 2000” manufactured by Avecia, and 1% by weight of “Irgacure 184” manufactured by Ciba Specialty Chemicals, K.K. were dispersed in 57.25% by weight of isopropanol to prepare a material for interference fringe preventive layer A formation. The material for interference fringe preventive layer A formation having a solid content of 40% was suitably diluted with isopropanol to regulate the solid content to 5 to 20%, and Benard cell was controlled by regulating the coating thickness and drying conditions. The coating thickness was 20 to 30 μm before drying and was 1 to 6 μm after drying. The drying temperature was 40 to 70° C. because a drying temperature of 70° C. or above causes uneven drying. The refractive index was 1.59, and the surface roughness Rz was 0.2 to 0.7 μm.

Interference Fringe Preventive Layer B

30% by weight of “electrically conductive fine powder T-1” manufactured by Mitsubishi Materials Corporation, 15% by weight of “DPHA” manufactured by Nippon Kayaku Co., Ltd., 5% by weight of “SOLSPERSE 2000” manufactured by Avecia, and 1% by weight of “Irgacure 184” manufactured by Ciba Specialty Chemicals, K.K. were dispersed in 49% by weight of isobutanol to prepare a dispersion of “electrically conductive fine powder T-1.” Next, a proper amount of isobutanol calculated based on the target solid content was added, and 158% by weight of “IPA-ST-UP” manufactured by Nissan Chemical Industries Ltd. was added to the dispersion of “electrically conductive fine powder T-1” to prepare a material for interference fringe preventive layer B formation. When the material for interference fringe preventive layer B formation is not less than 40% on a solid basis, the dispersion stability is extremely deteriorated. Therefore, the procedure required for compounding was different from that in the case of the solution for interference fringe preventive layer A formation. Benard cell was controlled by coating thickness and drying conditions. The coating thickness was 1 to 6 μm. Even when the drying temperature was 100° C. or above, uneven drying is less likely to occur. From the viewpoint of the heat resistance of the plastic film as the substrate, however, a drying temperature of 40 to 100° C. was adopted. The refractive index was 1.56, and the surface roughness Rz was 0.2 to 3.5 μm.

Hard Coat Layer A

Hard coat layer A was formed using a material for acryl hard coat layer formation having a solid content of 45% by weight, comprising “PET-30” manufactured by Dainichiseika Color & Chemicals Manufacturing Co., Ltd. and cyclohexanone. The thickness was 5 μm, and the refractive index was 1.5.

Hard Coat Layer B

Hard coat layer B was formed using a zirconia-dispersed hard coat material having a solid content of 30%, comprising “KZ 7973” manufactured by JSR Corporation and cyclohexanone. The thickness was 5 μm, and the refractive index was 1.69.

Hard Coat Layer C

Hard coat layer C was formed using a zirconia-dispersed hard coat material having a solid content of 30%, comprising “KZ 7973” manufactured by JSR Corporation, “PET-30” manufactured by Dainichiseika Color & Chemicals Manufacturing Co., Ltd., and cyclohexanone. The composition ratio between KZ-7973 and PET-30 in a dry state was brought to 50% by weight: 50% by weight which could provide a refractive index of 1.59 equal to the refractive index of the interference fringe preventive layer A. The thickness was 5 μm.

The material for interference fringe preventive layer A formation and the material for interference fringe preventive layer B formation prepared according to the above formulations were adjusted to respective proper solid contents with isopropanol and isobutanol. The coating liquids were coated, followed by drying to form an interference fringe preventive layer A and an interference fringe preventive layer B each having surface concaves and convexes. Hard coat layers A to C were coated to a layer thickness of 5 μm after drying on the interference fringe preventive layer to prepare samples.

Regarding the interference fringe preventive layer, processing conditions of solid content, coating thickness, and drying temperature, together with the results of measurement, are shown in Table 1.

Measurement

Surface Concaves and Convexes

A surface roughness measuring apparatus SE-3400 manufactured by Kosaka Laboratory Ltd. was used.

Interference Fringe/Pattern

A black vinyl tape “NO 200-38-21 black” manufactured by YAMATO Co., LTD. was applied to the backside of the hard coat, and the density of interference fringes was visually inspected under a three-wavelength fluorescent lamp.

The evaluation was carried out based on the following three stages.

X: No improvement was observed as compared with the case where interference fringe preventive layers having a smoothness in terms of roughness of Rz=not more than 0.2 μm and a thickness of 2 μm used under individual conditions were provided and a 5 μm-thick hard coat layer was then stacked thereon.

◯: Improvement was observed.

⊚: Interference fringes were improved to such a level that was not substantially noticeable from the practical point of view.

[Results of Measurement]

Processing conditions, surface shape of interference fringe preventive layer, and the results of the evaluation of appearance are shown in Table 1 below.

TABLE 1

| | Interference fringe preventive layer | | | | | | | |
|---|---|---|---|---|---|---|---|---|
| | | | Processing conditions | | Surface | | | |
| | Formulation | | Coating | | concaves and | | | |
| | | Solid | thickness | Drying | convexes | Hard | Evaluation of appearance | |
| Sample | Material | content, | before drying, | temp., | Rz, | coat | Interference | |
| No. | system | % | μm | ° C. | μm | layer | fringe | Smoothness |
| 1 | A | 5 | 20 | 40 | 0.25 | A | X | ◯ |
| 2 | A | 5 | 20 | 50 | 0.35 | A | X | ◯ |
| 3 | A | 10 | 20 | 50 | 0.41 | A | ◯ | ◯ |
| 4 | A | 10 | 25 | 70 | 0.55 | A | ◯ | ◯ |
| 5 | A | 10 | 25 | 70 | 0.55 | B | ◯ | ◯ |
| 6 | A | 10 | 25 | 70 | 0.55 | C | X | ◯ |
| 7 | A | 10 | 30 | 70 | 0.71 | A | ⊚ | ◯ |
| 8 | A | 10 | 30 | 70 | 0.72 | B | ⊚ | ◯ |
| 9 | A | 10 | 30 | 70 | 0.71 | C | X | ◯ |
| 10 | B | 5 | 20 | 50 | 0.33 | A | X | ◯ |
| 11 | B | 7.5 | 20 | 50 | 0.36 | A | X | ◯ |
| 12 | B | 7.5 | 20 | 50 | 0.37 | B | X | ◯ |
| 13 | B | 7.5 | 20 | 70 | 0.45 | A | ◯ | ◯ |
| 14 | B | 7.5 | 20 | 70 | 0.45 | B | ◯ | ◯ |
| 15 | B | 7.5 | 20 | 70 | 0.45 | C | ◯ | ◯ |
| 16 | B | 7.5 | 20 | 100 | 0.75 | A | ⊚ | ◯ |
| 17 | B | 7.5 | 20 | 100 | 0.75 | B | ⊚ | ◯ |
| 18 | B | 7.5 | 20 | 100 | 0.75 | C | ⊚ | ◯ |
| 19 | B | 7.5 | 30 | 70 | 0.98 | A | ⊚ | ◯ |
| 20 | B | 7.5 | 30 | 100 | 1.95 | A | ⊚ | ◯ |
| 21 | B | 7.5 | 40 | 100 | 2.62 | A | ⊚ | ◯ |
| 21 | B | 7.5 | 50 | 100 | 3.5 | A | ⊚ | ◯ |
| 22 | B | 10 | 50 | 100 | 3.77 | A | ⊚ | X |

1. An optical film comprising a plurality of transparent layers, wherein
a first transparent layer and a second transparent layer, provided in contact with said first transparent layer, constituting said optical film, are different from each other in refractive index of material constituting the layer, and
a contact interface between said first transparent layer and the second transparent layer is a light scattering interface, whereby the occurrence of interference fringes is suppressed.

2. The optical film according to claim 1, wherein the contact interface between said first transparent layer and the second transparent layer is a light diffusing interface having a ten-point mean roughness Rz=not less than 0.4 μm as measured according to JIS B 0601-1994.

3. The optical film according to claim 1 or 2, wherein said first transparent layer comprises a substrate layer and an interference fringe preventive layer and the surface of the interference fringe preventive layer constitutes said light scattering interface.

4. The optical film according to claim 3, wherein the material constituting said interference fringe preventive layer has a refractive index which is substantially equal to that of the material constituting said substrate layer.

5. The optical film according to claim 3 or 4, wherein said interference fringe preventive layer has been formed by a Benard cell method.

6. The optical film according to any one of claims 1 to 5, which comprises at least one of an antireflection layer, an antistatic layer, and an antifouling layer.

7. The optical film according to claim 1, which is an antireflection film comprising a transparent substrate layer and, provided on said transparent substrate layer in the following order, said first transparent layer comprising an antistatic layer and said second transparent layer comprising a hard coat layer.

8. An optical display device comprising the optical film according to any one of claims 1 to 7.
